(19) United States
(12) Patent Application Publication
(10) Pub. No.: US 2004/0225757 A1
(43) Pub. Date: Nov. 11, 2004

(54) Method and device for the automatic configuration of a document processing device

(75) Inventors: Jean-Jacques Moreau, Rennes (FR); Stephane Amarger, Chaville (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Pays-Bas (NL)

(21) Appl. No.: 10/842,299

(22) Filed: May 10, 2004

Related U.S. Application Data
(63) Continuation of application No. 09/503,896, filed on Feb. 15, 2000, now abandoned.

(30) Foreign Application Priority Data
Feb. 17, 1999 (FR) 9901924

(51) Int. Cl. G06F 15/00

(52) U.S. Cl. 710/8

(57) ABSTRACT

A method for the automatic configuration of a computer peripheral for processing a computer document, the processing including a step (E10) of translation of the instructions by a driver of the computer peripheral associated with means of storing the configuration of the computer peripheral, includes the steps of temporary storing (E1) of the instructions; analysing (E3) the content of the computer document from the stored instructions; choosing (E8) a correct configuration of the computer peripheral according to the content of the document; and entering (E9) this chosen configuration in the configuration storage means associated with the driver.

These steps of temporary storing (E1), analysing (E3), choosing (E8) and entering (E9) are implemented before the step (E10) of translation of the instructions by the driver.

This application is a continuation of application Ser. No. 09/503,896, filed Feb. 15, 2000.

The present invention concerns a method and a device for the automatic configuration of a computer peripheral for processing a computer document.

Computer systems generally Include one or more processing peripherals which can be seen as computing tools allowing the processing of computer documents, and notably the acquisition, transfer or representation of computer data.

These peripherals generally have parameterizable operating modes whose parameters are set:

either at the time of manufacture of the peripheral,

or, by default, by the central unit of the computer system;

or by a dialogue between the user and this computer system

For example, in the particular case of a peripheral composed of a printer, the configuration thereof notably takes into account parameters concerning the type of ink or paper used, the desired resolution or the printing speed.

It is moreover preferable that this configuration takes account of the characteristics of the document to be processed, and notably its graphic content when the printing of a document is concerned.

If it Is wished to make best use of a peripheral, it is necessary to adjust a large number of parameters and for each one to set its appropriate value amongst all those possible offered by the peripheral.

Such configuration is tiresome to perform upon processing each document.

It is moreover not very accessible to the normal user of computer systems.

Also, in practice, it is observed that the processing peripherals are not used to the best of their capability for processing computer documents, and that, very often, all the documents are processed uniformly, without modifying the basic configuration which offers a medium processing quality for all the documents.

The present invention aims to remedy these drawbacks.

To that end, the present invention concerns, according to a first aspect, a method for the automatic configuration of a computer peripheral for processing a computer document, this processing including a step of translation of the instructions by a driver of the computer peripheral associated with configuration storage means for said computer peripheral.

In accordance with the invention, this computer configuration method includes the following steps:

temporary storing of said instructions;

analysing the content of the computer document from said stored instructions;

choosing a correct configuration of the computer peripheral according to the content of said document; and

entering said chosen configuration in the configuration storage means associated with said driver,

said steps of temporary storing, analysing, choosing and entering being Implemented before said step of translation of the instructions by the driver.

The configuration method makes it possible to modify the configuration of the processing peripheral before the instructions are translated by the driver of this peripheral, that is to say converted so as to be readable and effected by this peripheral.

The modification of the configuration is transparent to the user as soon as the latter has initialized the processing of a computer document.

It makes It possible to take into account the content of the document directly from instructions which will effectively be received by the driver in order to adapt the configuration of the driver to the content of the document to be processed.

According to a preferred characteristic of the invention, this configuration method also comprises a step of obtaining additional data before the step of choosing a correct configuration.

The configuration of the driver of a peripheral can thus be modified not only from the content of the document to be processed but also according to certain other parameters which depend on the operating conditions of the peripheral and also on the wish of the user.

In practice, this obtaining step can be effected by the reading of operating parameters of said peripheral amongst at least a type of printing ink used and a type of paper.

There can thus be prerecorded a number of parameters which are not modified over time, or then only very occasionally.

This embodiment makes it possible to avoid the user having to reference these parameters at each new processing.

In another embodiment, and possibly as an addition to that described previously, this obtaining step Is effected by interrogating a user on operating parameters of said peripheral amongst at least a draft operating mode, a type of printing ink and a type of paper.

This embodiment allows a greater operating flexibility of the peripheral.

According to another preferred version of the invention, the temporary storing step is adapted to store instructions grouped by page of the computer document.

This characteristic makes it possible to cut up the document to be processed into processing units for which a different configuration can if necessary be applied to the peripheral according to the content of each page of the document to be processed.

In a particularly practical manner when it is a question of representing a document, on a screen or by printing on a paper mediums the temporary storing step is adapted to store graphic instructions, and the analysing step includes the following substeps:

seeking the existence or not of open graphic functions;

seeking the existence or not of closed graphic functions;

seeking the existence or not of bitmap representations; and

seeking the existence or not of text functions.

According to another preferred characteristic of the invention, the choosing step is adapted to choose said correct configuration amongst a set of prerecorded configurations for said peripheral which are dependent on the content of the document.

Thus, the configuration is effected relatively simply, by applying an example prerecorded configuration which Is particularly well suited to the content of the document.

This correct configuration can thus be prerecorded from data supplied by the manufacturer of the peripheral who knows the capabilities offered by the peripheral sufficiently well to adapt the configuration thereof to the content of the document to be processed.

In a particularly advantageous embodiment of the invention, which makes it possible to also take Into account operating parameters of the peripheral or wishes of the user, the choosing step is adapted to choose said correct configuration amongst a set of prerecorded configurations for said peripheral which are dependent on the content of the document and additional data obtained at said obtaining step.

In practice, when the peripheral makes it possible to represent a document on a screen or on a paper medium, the set of prerecorded configurations includes at least one configuration for a draft operating mode, one configuration for the processing of images, one configuration for the processing of graphics and one configuration for the processing of a text.

The processing of the document is thus adapted to its graphics content.

In an advantageous embodiment, the set of prerecorded configurations includes several subsets containing one configuration for a draft operating mode, one configuration for the processing of images, one configuration for the processing of graphics and one configuration for the processing of a text, each subset being defined for a unique combination of the type of printing ink and paper used.

Thus, for a given peripheral, there is a very large number of possible configurations, depending on the number of possible combinations between the type of ink and the type of paper used.

According to another of its aspects, the invention also concerns a device for the automatic configuration of a computer peripheral for processing a computer document, the processing including a step of translation of the instructions by a driver of said computer peripheral associated with configuration storage means for said computer peripheral.

According to the Invention, this automatic configuration device includes:

means of temporary storing of said instructions;

means of analysing the content of the computer document from said stored instructions;

means of choosing a correct configuration of the computer peripheral according to the content of said document; and

means of entering said chosen configuration in the configuration storage means associated with said driver.

In a practical embodiment of the invention, the processing peripheral is a printer or a facsimile machine.

The present invention also concerns a computer, a printer and a data acquisition system comprising a configuration device according to the invention or means adapted to implement the configuration method according to the invention.

It also concerns a computer communication network, including at least one computer and a peripheral for processing a computer document connected to said computer via the network, this computer comprising a configuration device according to the Invention.

The invention also relates to a computer program on an Information medium, such as a diskette or compact disk, characterised in that It implements the configuration method according to the invention, and a memory, such as a diskette or compact disk, intended to be read by a data processing system, characterised in that it carries instructions of a program whose execution by the processing system implements the automatic configuration method according to the invention.

More generally, the invention also relates to a computer program product comprising software code portions for implementing the configuration method according to the invention.

The advantages of this device, this computer, this data acquisition system, this network, this computer program and this memory are identical to those of the method as briefly described above.

Other characteristics and advantages of the invention will emerge further in the following description.

In the accompanying drawings, given by way of non-limitative example embodiments:

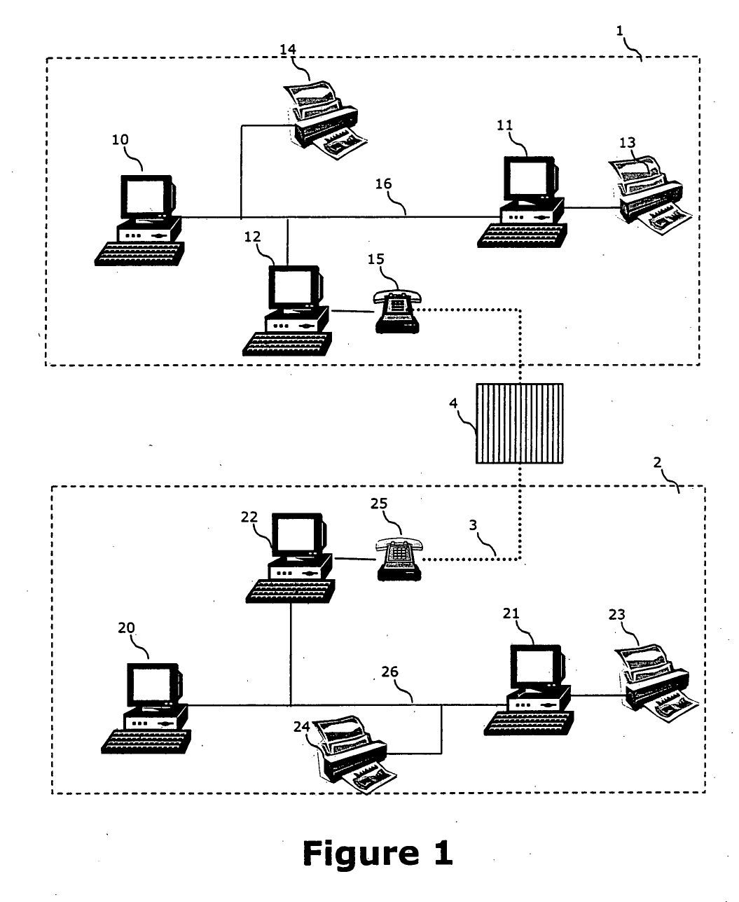

FIG. 1 illustrates a computer communication network adapted to implement the invention;

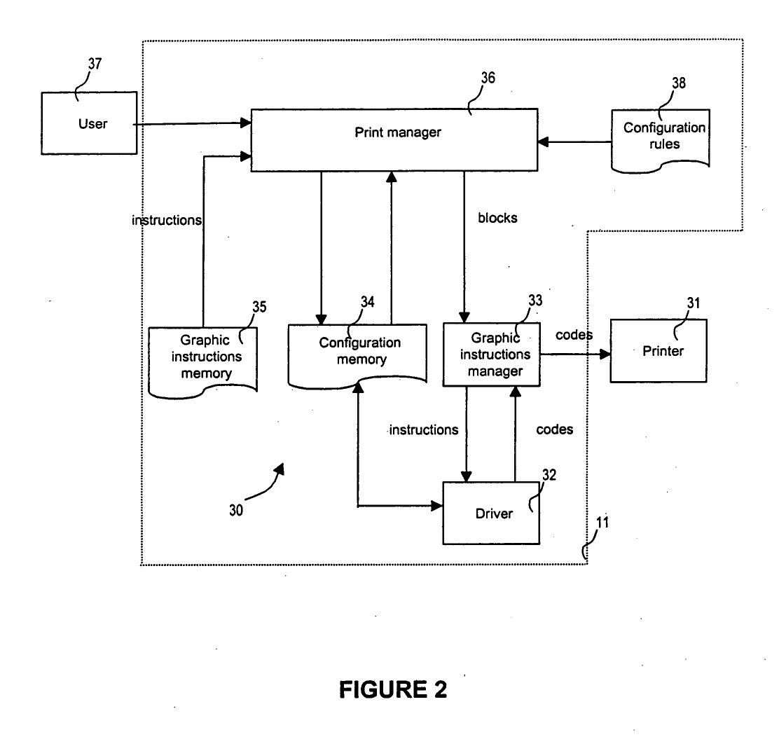

FIG. 2 illustrates a computer configuration device according to one embodiment of the invention;

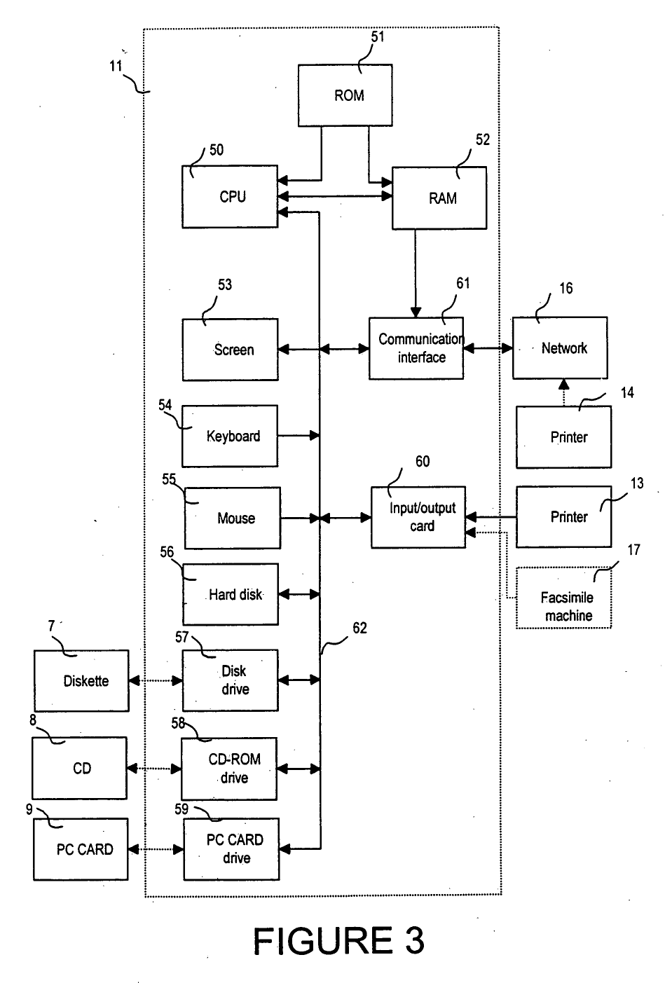

FIG. 3 depicts schematically a computer adapted to implement the configuration method according to the invention;

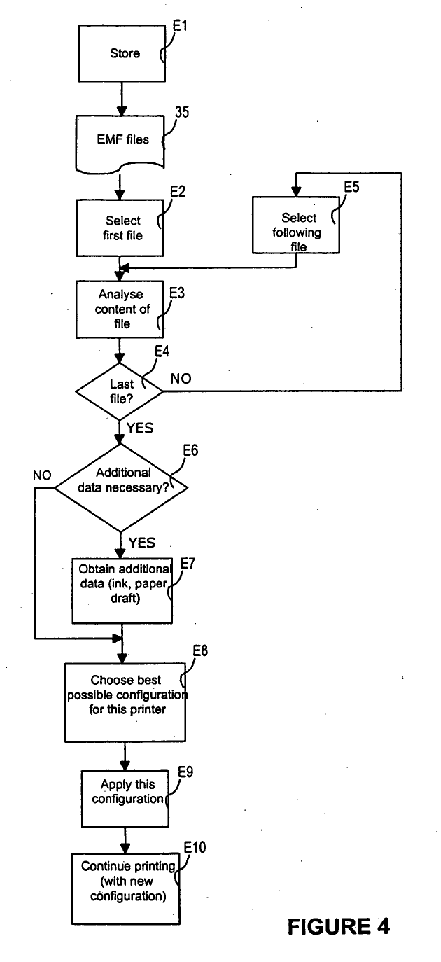

FIG. 4 depicts a flow diagram illustrating the automatic configuration method according to one embodiment of the Invention;

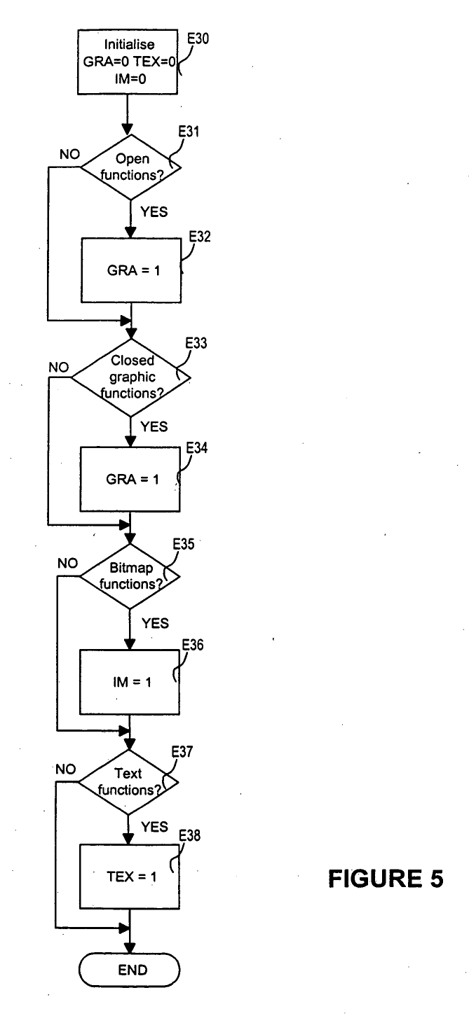

FIG. 5 illustrates an operational flow diagram detailing the analysing step of the configuration method illustrated in FIG. 4; and

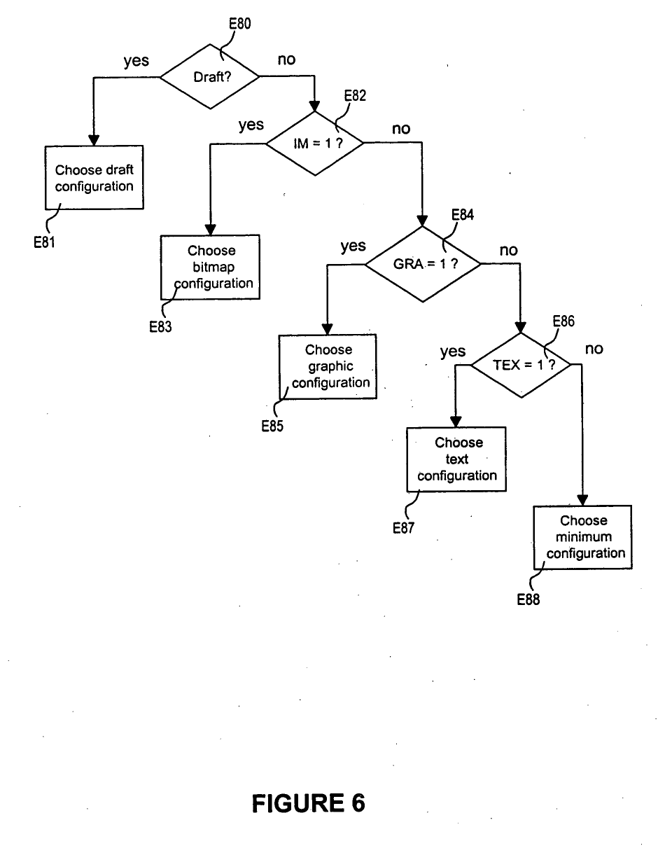

FIG. 6 illustrates an operational flow diagram detailing the step of choosing a correct configuration of the configuration method illustrated in FIG. 4.

There will first of all be described, with reference to FIG. 1, a communication network adapted to implement the invention. This network 1 includes several computers 10, 11, 12 interconnected by a network 16 of a particular type, for example by an Ethernet network.

Processing peripherals can be connected to these computers in order to implement different types of processing of a document.

In this example, the processing peripherals are printers 13, 14.

Of course, other processing peripherals could be connected to the network 1, and notably a facsimile machine, a modem, a scanner, an electronic whiteboard including or connected to a printer, and more generally any device for acquisition or representation of computer data.

These peripherals can equally well be connected to the network 1 either directly like the printer 14, or by means of a computer 11 like the printer 13. The connections used for connecting the peripherals, to the network 1 and to the computers are of appropriate types customary in computer networks: serial, parallel or SCSI (Small Computer Simple Interface).

This first network 1 can itself be connected to a second network 2 which also includes a number of computers 20, 21, 22 and printers 23, 24 as processing peripherals.

The computers 12, 22 of the two networks 1, 2 are connected respectively to a modem 15, 25 which are themselves connected by means of a network 3 and, by way of a non-limitative example, via a switch 4 which is situated at an access provider common to the two networks 1, 2.

This structure allows the two networks 1, 2 to communicate so that a user of a first network 1 can use the elements and notably the peripherals of the second network 2 as if they belonged physically to the first network, and vice versa.

For example, a document stored on the computer 11 of the first network can not only be printed on the printers 13 or 14 of the first network but also on the printers 23 or 24 of the second network.

There will now be described the structure of the automatic configuration device which can be incorporated in one or more of the computers 10, 11, 12, 20, 21, 22 of the communication networks 1, 2 described previously.

This automatic configuration device 30 as illustrated in FIG. 2 makes It possible to configure a computer peripheral for processing a computer document.

In the remainder of the description, the peripheral under consideration will be, non-limitatively, a printer 31.

In a known manner, a printer 31 is controlled by a driver 32 which is a software module situated In a computer system including a processor, such as a computer. This module is dedicated to communication with another system possessing its operating software for performing a set of elementary operations.

The driver 32 thus translates a complex operation requested by a high-level software application into a set of elementary operations executable by the printer. The driver thus performs a translation of a set of instructions, for example graphic instructions sent by a graphic instructions manager 33, into a set of codes readable by the printer 31.

The configuration of a driver 32 amounts to setting the value of each parameter of this translation. These parameters concern for example the translation of the character set of a text into a series of dots capable of being formed by the printer 31, or the palette of colours of a document into a palette of colours of the printer 31.

This configuration of the driver 32 is thus stored in configuration storage means 34 for the printer 31.

The configuration device includes means of temporary storing 35 of instructions, here graphic instructions.

These instructions are of the “draw a line”, “draw an ellipse”, “draw a bitmap representation” type, for example.

These temporary storing means 35 are adapted to store Instructions grouped by page of the computer document to be printed.

For example, in a computer system managed under Windows®, the graphic instructions sent by an application are received by a manager of graphic instructions (called GDI under Windows®) and stored in EMF files (Enhanced MetaFiles), each file corresponding to one document page.

An SPL file (Spool File) is also created to make an index of all the references of existing EMF files for the document and also to store the configuration of the driver 32 as parameterized at the time the application starts printing the document.

Thus, under Windows®, the configuration storage means 34 are incorporated in the SPL file.

Conventionally, a print manager 36 (Print Processor under Windows®) retrieves the graphic instructions stored in the EMF files and sends them in blocks to the graphic instructions manager 33 which in its turn transmits them to the driver 32.

The latter translates these instructions into the form of codes, from the configuration as stored in the SPL file.

The codes are returned to the graphic instructions manager 33 in order to be next sent to the printer 31 which can thus effect the actual printing of the document.

Of course, in a print system in which there exists no temporary storage for the graphic instructions in EMF files, the configuration device according to the invention includes specific means for storing graphic instructions which come from the application.

According to the invention, the configuration device also includes means of analysing the content of the computer document from these stored instructions.

These analysis means are preferably Incorporated in the print manager 36 (Print Processor under Windows®).

When the stored instructions are graphic instructions, the analysis means are adapted the seek the existence or not of open graphic functions, closed graphic functions, bitmap representations and text functions.

The configuration device also includes, in the print manager 36, means of obtaining additional data to be supplied to the means of choosing a correct configuration.

For a printer for example, these obtaining means are adapted to read operating parameters of the printer, which are independent of the document, such as the type of printing ink used and the type of paper loaded in the printer.

These additional data can be stored In a specific memory area by the user 37 when they do not vary over time Of course, the obtaining means can be adapted to interrogate a user 37 on these operating parameters of the printer, each time printing of a document is initialised.

In this case, the additional data can also comprise information on the choice or not of a draft operating mode of the printer which allows the user 37 to obtain the printing of a document quickly.

The configuration device also includes, in the print manager 36, means of choosing a correct configuration of the printer according to the content of the document.

These choosing means cooperate with a set of prerecorded configurations 38 for this printer 31, which are dependent on the content of the document and preferably also additional data obtained by the aforementioned obtaining means.

Thus, practically, for printing a document, this set of prerecorded configurations 38 includes one configuration for a draft operating mode, one configuration for the processing of images, one configuration for the processing of graphics and one configuration for the processing of a text, multiplied by the number of possible combinations of type of printing ink and type of paper used.

The configuration device also includes means of entering the chosen configuration in the configuration storage means 34 associated with the driver 32.

These entering means are also Incorporated in the print manager 36 and make it possible to replace the configuration stored In the SPL file under Windows® with the chosen configuration which is particularly well adapted to the printing of the document.

All the aforementioned means of the configuration device are incorporated in a computer 11 as illustrated In FIG. 3.

More precisely, the configuration device is incorporated in a microprocessor 50 (CPU), a read only memory (ROM) 51 being adapted to store a program for automatically configuring a peripheral for the processing of a computer document, and a random access memory (RAM) 52 containing registers for storing the variables modified during the execution of this program.

This microprocessor 50 is integrated in the computer 11 which can be connected to different peripherals, for example a printer 13 or a facsimile machine 17, by means of an input/output card 60, in order to be able to process documents, and notably print them.

This computer 11 includes a communication interface 61 connected to the communication network 16 for transferring or taking delivery of documents via the network 1 and receiving or sending information. The computer 11 can, by means of the network 16, be connected to another printer 14.

The computer 11 also includes document storage means, such as a hard disk 56, or is adapted to cooperate by means of a disk drive 57, a CD-ROM drive 58 or a PC Card drive. 59 with removable document storage means, respectively diskettes 7, compact disks (CD-ROMs) 8 or PC Cards 9.

These fixed or removable storage means can also include the code of the configuration method according to the Invention, which, once read by the microprocessor 50, will be stored on the hard disk 56.

By way of a variant, the program allowing the configuration device to implement the invention can be stored in the read only memory 51.

As a second variant, the program can be received in order to be stored as described previously by means of the communication network 16.

The computer 11 also has a screen 53 serving for example as an interface with a user 37 with the help of the keyboard 54 or the mouse 55 or any other means.

The central unit 50 will execute the instructions relating to implementation of the invention. On power-up, the programs and procedures relating to the invention stored in a non-volatile memory, for example the read only memory 51, are transferred to the random access memory 52 which will then contain the executable code of the invention and the variables necessary for implementing the invention.

The random access memory 52 thus contains registers for the temporary storing of graphic instructions and for storing the configuration of the driver 32.

The read only memory 51 can store the set of prerecorded configurations 38 as well as the code of the program to be executed for automatically configuring the driver according to the content of the document.

A communication bus 62 allows communication between the different sub-elements of the computer 11 or those connected thereto. The representation of the bus 62 is not limitative and notably the microprocessor 50 is capable of communicating instructions to any sub-element directly or by means of another sub-element.

There will now be described the automatic configuration method implemented by this device with reference to FIGS. 4 to 6.

When the user initialises the printing of a document by a printer, for example a printer local to the computer on which the document is stored, the graphic instructions are sent by the application to the driver 32 of the printer 31, by means of the graphic instructions manager 33, with a view to the translation of these instructions by the driver 32.

Before this step, the configuration method according to the invention includes a step of temporary storing E1 of the graphic instructions.

Under Windows®, this step is implemented by storing the graphic instructions in EMF files. These files thus form a buffer memory which makes it possible to free the application during the period of the printing and notably while the driver is processing the graphic instructions sent to it.

The graphic instructions are thus grouped by page of the computer document.

A step of analysing E3 the content of the computer document is next implemented from the instructions stored in the EMF files 35.

The first file is selected in a selection step E2, Its content is analysed, and then it is checked in a test step E4 whether this is the last file.

In the negative, the following file is selected at a selection step E5 and the previous steps E3 and E4 are reiterated.

As illustrated in detail in FIG. 5, the analysing step E3 itself comprises an initialisation step E30 in which flags GRA, IM and TEX are initialised to an initial value, for example 0.

It is first checked in a step E31 whether there are, in the EMS file, open graphic functions, of the type of a curve, a straight line, an arc, etc.

In the affirmative, in a step E32, the value of the flag GRA is modified, associating therewith for example the value 1.

Whatever the reply, next, in a step E33, it is checked whether there are, in the EMF file, closed graphic functions of the type of a circle, a rectangle, a polygon, etc.

In the affirmative, in a step E34, the value of the flag GRA is modified, associating therewith for example the value 1.

Whatever the reply, next, in a step E35, it is checked whether there are bitmap representations in the EMF file, signifying that an image exists.

In the affirmative, in a step E36, the value of the flag IM is modified, associating therewith for example the value 1.

Whatever the reply, finally, in a step E37, it Is checked whether there is text in the EMF file.

In the affirmative, in a step E38, the value of the flag TEX is modified, associating therewith for example the value 1.

The content of each EMF file is thus analysed automatically in order to ascertain the graphic functions which must be drawn by the printer.

A test step E6 makes it possible to check whether additional data are necessary for choosing the configuration. Such is the case for example when the prerecorded configurations are dependent on the type of paper and the type of printing ink used.

In a step E7, these additional data are then obtained either by reading, from a specific memory, the type of printing ink used and the type of paper placed in the printer, or by interrogating the user on this type of ink and paper and on the possible choice of a draft quality print mode which makes it possible to obtain lower quality but faster printing of the document.

The automatic configuration method according to the invention next includes a step E8 of choosing a correct configuration of the printer 31 according to the content of the document.

In this example the correct configuration is chosen amongst a set of prerecorded configurations for this printer 31 which are dependent on the content of the document and additional data obtained at said obtaining step E7.

Thus, the set of prerecorded configurations includes, for each combination of ink and paper, at least one configuration for a draft operating mode, one configuration for the processing of images, one configuration for the processing of graphics and one configuration for the processing of a text.

As illustrated in FIG. 6, the choice of this configuration is effected according to the following hierarchy, for a fixed combination of ink and paper.

First of all it is checked in a step E80 whether the draft printing mode has been requested by the user.

In the affirmative, the draft configuration is chosen at the step E81, which makes it possible to obtain medium quality printing, generally in black and white.

Otherwise, the choosing process continues and it is checked at the step E82 whether the flag IM is equal to 1, that is to say whether the document comprises images.

In the affirmative, at the step E83, a configuration for image processing, or a bitmap configuration, is chosen. This configuration generally offers high-resolution colour printing, which makes it possible to obtain a correct reproduction of images.

Otherwise, the choosing process continues and it is checked at the step E84 whether the flag GRA is equal to 1, that is to say whether the document includes drawings.

In the affirmative, at the step E85, a configuration for graphics processing, of lower resolution than that used for image processing, is chosen.

Otherwise, the choosing process continues and it is checked at the step E86 whether the flag TEX is equal to 1, that is to say whether the document Includes text.

In the affirmative a configuration well adapted for printing a text is chosen.

Otherwise, if none of the flags GRA, IM, TEX has the value 1, a minimum configuration is chosen, which can be the draft configuration or another predefined configuration.

Such may be the case if the document is empty or if it includes graphic instructions with no real application, such as for example “print the characters in blue” whereas the document includes no character to which this change in colour applies.

Practically, the chosen configuration comes in the form of a set of values to be applied to different configuration parameters of the driver 32.

Returning to FIG. 4, in a step E9, this chosen configuration is applied by entering it In the configuration: storage means 34 associated with the driver 32, that is to say under Windows®, in the SPL file.

In practice, this entering of a new configuration is equivalent to changing the value of the different parameters on which the operation of the printer 31 and the generation of codes by the driver 32 depend.

A conventional step E10 for continuing the printing is then implemented after the aforementioned steps of temporary storing E1, analysing E3, choosing E8 and entering E9.

Thus, the graphic Instructions are sent in blocks from the EMF files to the graphic instructions manager 33 by the print manager 36.

The graphic Instructions manager 33 then sends these instructions to the driver 32 which can translate them Into codes readable by 5 the printer 31 using the new configuration recorded beforehand in the memory 34.

Thus, the present invention makes it possible, by judiciously intercepting the graphic instructions before their translation by the printer driver, to configure said driver according to the content of the document. 10 The content of this document is moreover easily accessible by virtue of directly analysing the graphic instructions generated by the application at the time of printing.

The present invention thus makes it possible to automatically modify the configuration of the driver without acting directly thereon. 15 On a given computer, a set of prerecorded configurations can be stored for each printer accessible by this computer, either locally, or through the communication network in another embodiment, the configuration device 30 according to the invention could be partly or wholly incorporated in the printer, for example in 20 the printer 14 of the communication network 1 illustrated in FIG. 1.

All the means for storing, analysing, choosing and entering can be incorporated in the printer 14 and adapted to process the graphic instructions sent by a print manager before these graphic instructions are actually translated by the driver, itself incorporated in the printer. 25 Of course, many modifications can be made to the example embodiment described above without departing from the scope of the invention.

Thus, the processing peripheral can also be a facsimile machine or a modem, or even a scanner.

The number of prerecorded configurations for each printer can be 30 different.

Moreover, the analysing step can Include, besides the changing of a flag disclosing the presence of a type of graphic instruction, a step of calculating ratios, such as for example the ratio of the size of the image (In pixels) or of a graphic present in the document over the size of the print medium, so that, at the step of choosing, this is effected by taking Into account both the value of the flags and also the value of these ratios,

Thus, a value of the flag IM equal to 1 can be Ignored (that is to say the image configuration will not be chosen) if the ratio of the size of the image over the size of the paper is less than a certain value.

1. Method for the automatic configuration of a driver associated with computer peripheral for processing a computer document, said processing including a step of the translation of instructions for the processing of the document into a set of data readable by the computer peripheral, the instructions being translated by the driver of said computer peripheral associated with configuration storage means for said computer peripheral, characterised in that it includes the following steps:
temporarily storing the instructions for the processing of the computer document;
analysing the stored instructions in order to identify the content of the computer document;
automatically choosing amongst a plurality of configurations including configurations with different resolutions, a correct configuration of the driver, according to the content of said document, to translate the instructions for the processing of the computer document by the computer peripheral; and
entering said chosen configuration in the configuration storage means associated with said driver, wherein said steps of temporarily storing, analysing, choosing and entering are implemented before said step of translation of the instructions by the driver.

2. Automatic configuration method according to claim 1, characterised in that it also comprises a step of obtaining additional data before the step of choosing a correct configuration.

3. Configuration method according to claim 2, characterised in that said obtaining step is effected by the reading of operating parameters of said peripheral amongst at least a type of printing ink used and a type of paper.

4. Configuration method according to one of claims 2 or 3, characterised in that said obtaining step is effected by interrogating a user on operating parameters of said peripheral amongst at least a draft operating mode, a type of printing ink and a type of paper.

5. Configuration method according to one of claims 1 to 2, characterised in that the temporary storing step is adapted to store instructions grouped by page of the computer document.

6. Configuration method according to one of claims 1 to 2, characterised in that the temporary storing step is adapted to store graphic instructions and in that the analysing step includes the following substeps:
seeking the existence or not of open graphic functions;
seeking the existence or not of closed graphic functions;
seeking the existence or not of bitmap representations; and
seeking the existence or not of text functions.

7. Configuration method according to one of claims 1 to 2, characterised in that the choosing step is adapted to choose said correct configuration amongst a set of prerecorded configurations for said peripheral which are dependent on the content of the document.

8. Configuration method according to one of claims 2 to 3, characterised in that the choosing step is adapted to choose said correct configuration amongst a set of prerecorded configurations for said peripheral which are dependent on the content of the document and additional data obtained at said obtaining step.

9. Configuration method according to claim 8, characterised in that said set of prerecorded configurations includes at least one configuration for a draft operating mode, one configuration for the processing of images, one configuration for the processing of graphics and one configuration for the processing of a text.

10. Configuration method according to claim 8, characterised in that said set of prerecorded configurations includes several subsets containing one configuration for a draft operating mode, one configuration for the processing of images, one configuration for the processing of graphics and one configuration for the processing of a text, each subset being defined for a unique combination of the type of printing ink and paper used.

11. Device for the automatic configuration of a driver associated with a computer peripheral for processing a computer document, said processing including a step of translation of the instructions for the processing of the document into a set of data readable by the computer peripheral the instructions being translated by the driver of said computer peripheral associated with configuration storage means for said computer peripheral, characterised in that it includes:
means for temporarily storing the instructions for the processing of the computer document;
means for analysing the stored instructions in order to identify the content of the computer document;
means for choosing automatically amongst a plurality of configurations including configurations with different resolutions a correct configuration of the driver, according to the content of said document to translate the instructions for the processing of the computer document by the computer peripheral; and
means for entering said chosen configuration in the configuration storage means associated with said driver.

12. Automatic configuration device according to claim 11, characterised in that it also comprises means of obtaining additional data to be supplied to the means of choosing a correct configuration.

13. Configuration device according to claim 12, characterised in that the obtaining means are adapted to read operating parameters of said peripheral amongst at least a type of printing ink used and a type of paper.

14. Configuration device according to one of claims 12 or 13, characterised in that the obtaining means are adapted to interrogate a user on operating parameters of said peripheral amongst at least a draft operating mode, a type of printing ink and a type of paper.

15. Configuration device according to one of claims 11 to 12, characterised in that the temporary storing means are adapted to store instructions grouped by page of the computer document.

16. Configuration device according to one of claims 11 to 12, characterised in that the temporary storing means are adapted to store graphic instructions and in that the analysis means are adapted to seek the existence or not of open graphic functions, closed graphic functions, bitmap representations and text functions.

17. Configuration device according to one of claims 11 to 12, characterised in that the choosing means cooperate with a set of prerecorded configurations for said peripheral which are dependent on the content of the document.

18. Configuration device according to one of claims 12 to 13, characterised in that the choosing means cooperate with a set of prerecorded configurations for said peripheral which are dependent on the content of the document and additional data obtained by said obtaining means.

19. Configuration device according to claim 18, characterised in that said set of prerecorded configurations includes at least one configuration for a draft operating mode, one configuration for the processing of images, one configuration for the processing of graphics and one configuration for the processing of a text.

20. Configuration device according to claim 18, characterised in that said set of prerecorded configurations includes several subsets containing one configuration for a draft operating mode, one configuration for the processing of images, one configuration for the processing of graphics and one configuration for the processing of a text, each subset being defined for a unique combination of the type of printing ink and paper used.

21. Configuration device according to one of claims 11 to 12, characterised in that it is incorporated in a microprocessor, a read only memory being adapted to store a program for automatically configuring a peripheral for the processing of a computer document, and a random access memory containing registers for storing the variables modified during the execution of said program.

22. Configuration device according to one of claims 11 to 12, characterised in that the processing peripheral is a printer.

23. Configuration device according to one of claims 11 to 12, characterised in that the processing peripheral is a facsimile machine.

24. Computer, characterised in that it comprises means adapted to implement the automatic configuration method according to one of claims 1 to 2.

25. Computer, characterised in that it comprises a configuration device according to one of claims 11 to 12.

26. Computer communication network, including at least one computer and a peripheral for processing a computer document connected to said computer via the network, characterised in that said computer comprises a configuration device according to one of claims 11 to 12.

27. System for the acquisition of data forming a computer document, characterised in that it comprises means adapted to implement the automatic configuration method according to one of claims 1 to 2.

28. System for the acquisition of data forming a computer document, characterised in that it comprises a configuration device according to one of claims 11 to 12.

29. Printer, characterised in that it comprises means adapted to implement the automatic configuration method according to one of claims 1 to 2.

30. Printer, characterised in that it comprises a configuration device according to one of claims 11 to 12.

31. Computer program product, characterised in that it comprises software code portions for implementing the configuration method according to one of claims 1 to 2.
